(19) United States
(12) Patent Application Publication
(10) Pub. No.: US 2025/0196573 A1
(43) Pub. Date: Jun. 19, 2025

(54) SYSTEM AND METHOD FOR INTELLIGENT CABIN CONFIGURATION PRESETS

(71) Applicant: Rockwell Collins, Inc., Cedar Rapids, IA (US)

(72) Inventors: Sreekanth Yellavula, Hyderabad (IN); Norman J. Krieg, San Clemente, CA (US); Arunkumar Janarthanan, Arakkonam (IN); Bharghav Malla, Cedar Rapids, IA (US)

(21) Appl. No.: 18/614,298

(22) Filed: Mar. 22, 2024

(30) Foreign Application Priority Data
Dec. 18, 2023 (IN) 202311086408

(51) Int. Cl. B60H 1/00; B60K 35/10; B60K 35/22

(52) U.S. Cl. CPC B60H 1/0073; B60K 35/10; B60K 35/22; B60K 2360/1438

(57) ABSTRACT

A system and method is disclosed. The system may include a touchscreen display and one or more controllers communicatively coupled to the display. The controllers may include one or more processors configured to execute a set of program instructions stored in a memory. The program instructions may be configured to cause the processors to display at least one graphical user interface (GUI) on the touchscreen display. The GUI may be configured to control cabin features corresponding to an aircraft cabin and may include a suggestion mode activation area providing preset suggestions.

### CROSS-REFERENCE TO RELATED APPLICATIONS

The present application claims the benefit of India Provisional Patent Application 20/231,1086408, filed Dec. 18, 2023, titled SYSTEM AND METHOD FOR INTELLIGENT CABIN CONFIGURATION PRESETS, naming Sreekanth Yellavula, Norman J. Krieg, Arunkumar Janarthanan, and Bharghav Malla as inventors, which is incorporated herein by reference in the entirety.

### TECHNICAL FIELD

The present disclosure relates generally to cabin management systems and more particularly to presets providing for control of cabin functions.

### BACKGROUND

Aircraft Cabin Presets may include established combinations or settings for a variety of cabin components. These settings are created to maximize the cabin atmosphere for various flight stages, passenger preferences, and operational requirements. Cabin Presets improve passenger comfort and simplify cabin operations during the flight. Typically, an aircraft's cabin management system (CMS) is used to control cabin presets.

Many aircraft cabin management systems use default settings for various cabin features such as lighting, temperature, and the like. These systems may lack utility to help passengers and crew with preset suggestions.

### SUMMARY

A system is disclosed in accordance with one or more illustrative embodiments of the present disclosure. In one illustrative embodiment, the system may include a touchscreen display and one or more controllers communicatively coupled to the display. In another illustrative embodiment, the controllers may include one or more processors configured to execute a set of program instructions stored in a memory. In another illustrative embodiment, the program instructions may be configured to cause the processors to display at least one graphical user interface (GUI) on the touchscreen display, which is configured to control cabin features corresponding to an aircraft cabin and includes a suggestion mode activation area. In another illustrative embodiment, the system may activate a preset suggestion mode based on a user input of the suggestion mode activation area via the touchscreen display by a user. In another illustrative embodiment, the system may enable a selection of preset preferences based on the activation of the preset suggestion mode. In another illustrative embodiment, the system may receive the preset preferences based on preset preference user input via the touchscreen display. In another illustrative embodiment, the system may receive aircraft data including at least flight data. In another illustrative embodiment, the system may receive a neural network. In another illustrative embodiment, the system may generate preset suggestions via the neural network based on the preset preferences and the aircraft data. In another illustrative embodiment, the system may display the preset suggestions on the GUI. In another illustrative embodiment, the system may direct an adjustment of the cabin features based on the preset suggestions and at least one of a user input acceptance of the preset suggestions or an automatic acceptance of the preset suggestions, where the cabin features include at least one of a window level of one or more window shades, temperature control systems, or a cabin lighting level of one or more lights.

In a further aspect, the preset suggestions may be further based on a user identification corresponding and unique to the user. In another aspect, the one or more processors may be further configured to train the neural network based on the preset preferences. In another aspect, the GUI may include a preset display area, which may include the suggestion mode activation area. In another aspect, the aircraft data may further include occupancy data based on occupancy sensors configured to sense the user in the aircraft cabin and to associate the user with a user identification. In another aspect, the GUI may include a feature list area configured to list the cabin features. In another aspect, the GUI may include a default preset list area and a custom preset list area. In another aspect, the GUI may include a cabin image area comprising a visual representation of the cabin features. In another aspect, the activation of the preset suggestion mode may be further based on an affirmative determination that the preset suggestion mode is available. In another aspect, the aircraft data may further include aircraft usage data.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A illustrates a simplified block diagram of an aircraft including a system, in accordance with one or more embodiments of the present disclosure.

FIG. 1B illustrates an aircraft including a system, in accordance with one or more embodiments of the present disclosure.

FIG. 2 is a conceptual block diagram of training a neural network configured to output preset suggestions, in accordance with one or more embodiments of the present disclosure.

FIG. 3 is a conceptual block diagram of a cabin management system (CMS), in accordance with one or more embodiments of the present disclosure.

FIG. 4 is a graphical user interface (GUI) including global presets, in accordance with one or more embodiments of the present disclosure.

FIG. 5A is a graphical user interface (GUI) in a feature suggestion mode, in accordance with one or more embodiments of the present disclosure.

FIG. 5B is a feature specific list of FIG. 5A, in accordance with one or more embodiments of the present disclosure.

FIG. 6 is a flow diagram illustrating steps performed in a method for adjusting cabin features based on preset suggestions, in accordance with one or more embodiments of the present disclosure.

FIG. 7 is a flow diagram illustrating steps performed in a method for adjusting cabin features based on preset suggestions, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly, embodiments of the present disclosure are directed to a system and method for an AI-powered CMS Preset Assistant that provides dynamic and personalized cabin presets based on passenger preferences, flight conditions, and historical usage. At least some embodiments herein enable dynamic cabin setting presets (e.g., light levels, temperature settings, etc.) that consider cabin needs, passenger preferences, and/or flight conditions. Dynamic cabin presets may improve the in-cabin experience with adaptable environment control and/or may improve energy efficiency (e.g., reduce unnecessary energy usage).

At least some embodiments herein may be analogous to an ‘AI-Powered Wizard Configuration” features that improves cabin presets (e.g., default presets) significantly. The system may learn from past use and passenger preferences, providing personalized comfort. The system may also suggest and automate presets for efficiency, considering cabin requirements, passenger preferences, and/or flight conditions for optimized settings. The system may also use the dynamic presets to provide for adaptability and energy efficiency, enhancing the overall in-cabin experience.

The system may provide a selection (e.g., ON button or option to turn on the dynamic preset functions or the like) to enable such a mode of cabin presets based on learning past preferences and selections from the Cabin Management System (CMS) User based on considerations such as diverse flight scenarios. In this way, an AI-driven cabin atmosphere is made possible by such an ‘ON’ selection feature.

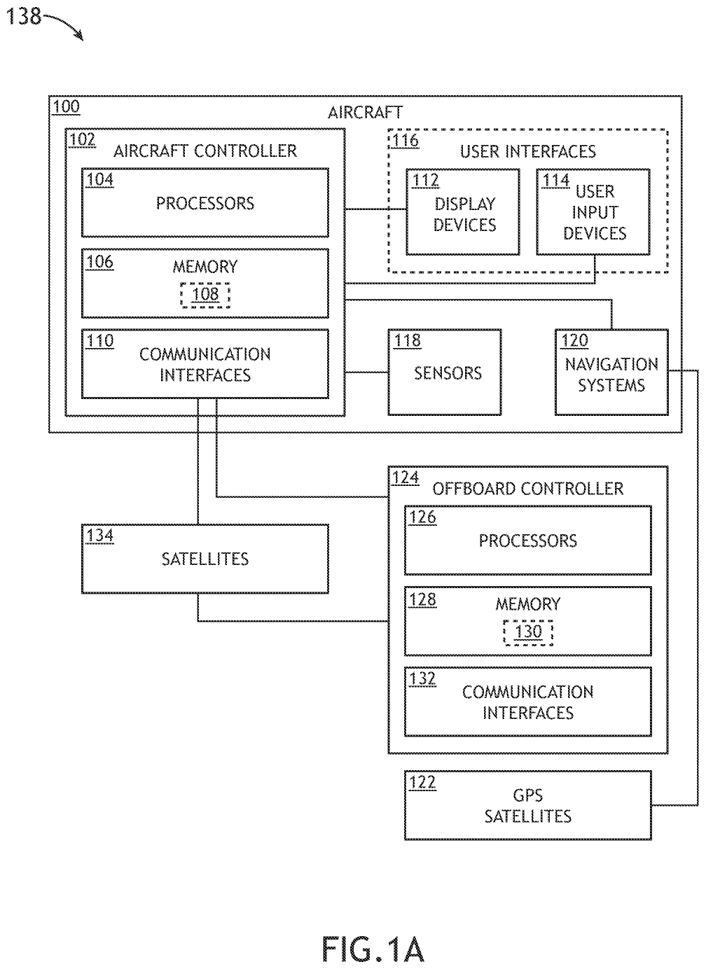

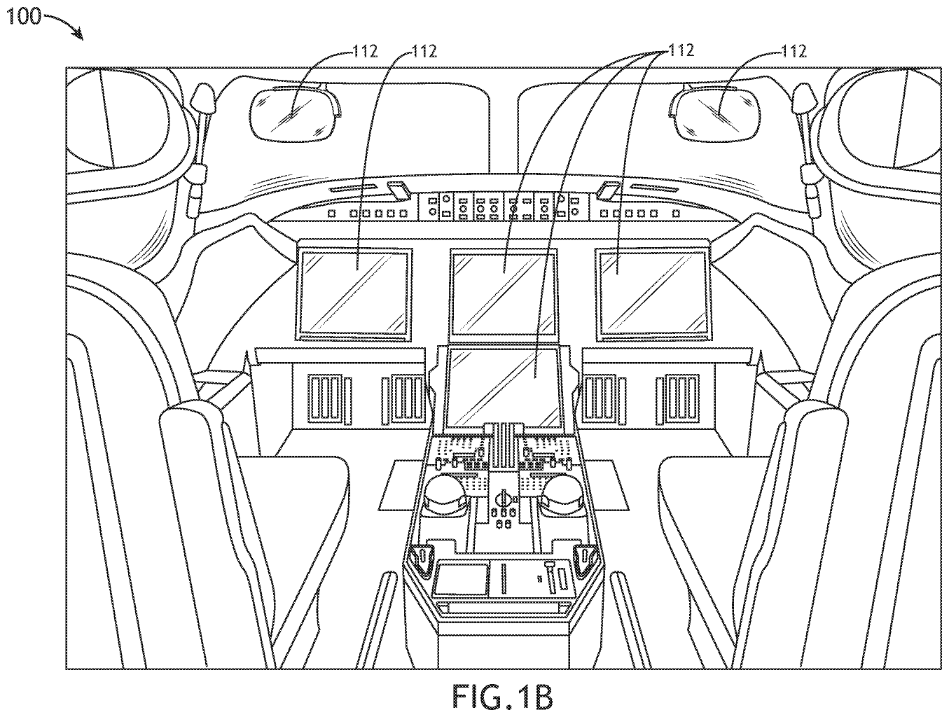

FIGS. 1A-1B illustrate an aircraft including a system for storing, generating/retrieving, and the like of terrain elevation data, in accordance with one or more embodiments of the present disclosure.

Referring now to FIG. 1A, the aircraft 100 may include an aircraft controller 102 (e.g., on-board/run-time controller). The aircraft controller 102 may include one or more processors 104, memory 106 configured to store one or more program instructions 108, and/or one or more communication interfaces 110.

In embodiments, the system may use one or more occupancy sensors 118 (e.g., any sensors such as a camera, seat weight sensor, microphone for listening for voices, radar, and/or the like) to determine occupancy. The occupany may be used for determining user identification (e.g., voice recognition, face recognition from camera, and/or the like). The occupany may be used for training and generating preset suggestions. For example, aircraft data may include comprises occupancy data based on occupancy sensors configured to sense one or more users in the aircraft cabin and to associate the users with user identification (e.g., numbers or names or codes unique to each person). For example, if a user typically turns down the lights on the side of a cabin without any users, then a lack of occupancy on a side of a cabin may cause, via training, the neural network to automatically dim the lighting on that side.

The aircraft 100 may include an avionics environment such as, but not limited to, a cabin. The aircraft controller 102 may be coupled (e.g., physically, electrically, and/or communicatively) to one or more display devices 112. The one or more display devices 112 may be configured to display three-dimensional images and/or two-dimensional images. Referring now to FIG. 1B, the avionics environment (e.g., the cabin) may include any number of display devices 112 (e.g., one, two, three, or more displays) such as, but not limited to, one or more head-down displays (HDDs) 112, one or more head-up displays (HUDs) 112, one or more multi-function displays (MFDs), one or more adaptive flight displays (AFDs) 112, one or more primary flight displays (PFDs) 112, or the like. The one or more display devices 112 may be employed to present flight data including, but not limited to, preset data.

Referring again to FIG. 1A, the aircraft controller 102 may be coupled (e.g., physically, electrically, and/or communicatively) to one or more user input devices 114. The one or more display devices 112 may be coupled to the one or more user input devices 114. For example, the one or more display devices 112 may be coupled to the one or more user input devices 114 by a transmission medium that may include wireline and/or wireless portions. The one or more display devices 112 may include and/or be configured to interact with one or more user input devices 114.

The one or more display devices 112 and the one or more user input devices 114 may be standalone components within the aircraft 100. It is noted herein, however, that the one or more display devices 112 and the one or more user input devices 114 may be integrated within one or more common user interfaces 116.

Where the one or more display devices 112 and the one or more user input devices 114 are housed within the one or more common user interfaces 116, the aircraft controller 102, one or more offboard controllers 124, and/or the one or more common user interfaces 116 may be standalone components. It is noted herein, however, that the aircraft controller 102, the one or more offboard controllers 124, and/or the one or more common user interfaces 116 may be integrated within one or more common housings or chassis.

The aircraft controller 102 may be coupled (e.g., physically, electrically, and/or communicatively) to and configured to receive data from one or more aircraft sensors 118. The one or more aircraft sensors 118 may be configured to sense a particular condition(s) external or internal to the aircraft 100 and/or within the aircraft 100. The one or more aircraft sensors 118 may be configured to output data associated with particular sensed condition(s) to one or more components/systems onboard the aircraft 100. Generally, the one or more aircraft sensors 118 may include, but are not limited to, one or more inertial measurement units, one or more airspeed sensors, one or more radio altimeters, one or more flight dynamic sensors (e.g., sensors configured to sense pitch, bank, roll, heading, and/or yaw), one or more weather radars, one or more air temperature sensors, one or more surveillance sensors, one or more air pressure sensors, one or more engine sensors, and/or one or more optical sensors (e.g., one or more cameras configured to acquire images in an electromagnetic spectrum range including, but not limited to, the visible light spectrum range, the infrared spectrum range, the ultraviolet spectrum range, or any other spectrum range known in the art).

The aircraft controller 102 may be coupled (e.g., physically, electrically, and/or communicatively) to and configured to receive data from one or more navigational systems 120. The one or more navigational systems 120 may be coupled (e.g., physically, electrically, and/or communicatively) to and in communication with one or more GPS satellites 122, which may provide vehicular location data (e.g., aircraft location data) to one or more components/systems of the aircraft 100. For example, the one or more navigational systems 120 may be implemented as a global navigation satellite system (GNSS) device, and the one or more GPS satellites 122 may be implemented as GNSS satellites. The one or more navigational systems 120 may include a GPS receiver and a processor. For example, the one or more navigational systems 120 may receive or calculate location data from a sufficient number (e.g., at least four) of GPS satellites 122 in view of the aircraft 100 such that a GPS solution may be calculated.

It is noted herein the one or more aircraft sensors 118 may operate as a navigation device 120, being configured to sense any of various flight conditions or aircraft conditions typically used by aircraft and output navigation data (e.g., aircraft location data, aircraft orientation data, aircraft direction data, aircraft speed data, and/or aircraft acceleration data). For example, the various flight conditions or aircraft conditions may include altitude, aircraft location (e.g., relative to the earth), aircraft orientation (e.g., relative to the earth), aircraft speed, aircraft acceleration, aircraft trajectory, aircraft pitch, aircraft bank, aircraft roll, aircraft yaw, aircraft heading, air temperature, and/or air pressure. By way of another example, the one or more aircraft sensors 118 may provide aircraft location data and aircraft orientation data, respectively, to the one or more processors 104, 126.

The aircraft controller 102 of the aircraft 100 may be coupled (e.g., physically, electrically, and/or communicatively) to one or more offboard controllers 124.

The one or more offboard controllers 124 may include one or more processors 126, memory 128 configured to store one or more programs instructions 130 and/or one or more communication interfaces 132.

The aircraft controller 102 and/or the one or more offboard controllers 124 may be coupled (e.g., physically, electrically, and/or communicatively) to one or more satellites 134. For example, the aircraft controller 102 and/or the one or more offboard controllers 124 may be coupled (e.g., physically, electrically, and/or communicatively) to one another via the one or more satellites 134. For instance, at least one component of the aircraft controller 102 may be configured to transmit data to and/or receive data from at least one component of the one or more offboard controllers 124, and vice versa. By way of another example, at least one component of the aircraft controller 102 may be configured to record event logs and may transmit the event logs to at least one component of the one or more offboard controllers 124, and vice versa. By way of another example, at least one component of the aircraft controller 102 may be configured to receive information and/or commands from the at least one component of the one or more offboard controllers 124, either in response to (or independent of) the transmitted event logs, and vice versa.

It is noted herein that the aircraft 100 and the components onboard the aircraft 100, the one or more offboard controllers 124, the one or more GPS satellites 122, and/or the one or more satellites 134 may be considered components of a system 138, for purposes of the present disclosure.

The one or more processors 104, 126 may include any one or more processing elements, micro-controllers, circuitry, field programmable gate array (FPGA) or other processing systems, and resident or external memory for storing data, executable code, and other information accessed or generated by the aircraft controller 102 and/or the one or more offboard controllers 124. In this sense, the one or more processors 104, 126 may include any microprocessor device configured to execute algorithms and/or program instructions. It is noted herein, however, that the one or more processors 104, 126 are not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., the memory), where the set of program instructions is configured to cause the one or more processors to carry out any of one or more process steps.

The memory 106, 128 may include any storage medium known in the art suitable for storing the set of program instructions executable by the associated one or more processors. For example, the memory 106, 128 may include a non-transitory memory medium. For instance, the memory 106, 128 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 106, 128 may be configured to provide display information to the display device (e.g., the one or more display devices 112). In addition, the memory 106, 128 may be configured to store user input information from a user input device of a user interface. The memory 106, 128 may be housed in a common controller housing with the one or more processors. The memory 106, 128 may, alternatively or in addition, be located remotely with respect to the spatial location of the processors and/or a controller. For instance, the one or more processors and/or the controller may access a remote memory (e.g., server), accessible through a network (e.g., internet, intranet, and the like).

The aircraft controller 102 and/or the one or more offboard controllers 124 may be configured to perform one or more process steps, as defined by the one or more sets of program instructions 108, 130. The one or more process steps may be performed iteratively, concurrently, and/or sequentially. The one or more sets of program instructions 108, 130 may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal component analysis (PCA), multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions 108, 130 may be configured to operate via proportional control, feedback control, feedforward control, integral control, proportional-derivative (PD) control, proportional-integral (PI) control, proportional-integral-derivative (PID) control, or the like.

The one or more communication interfaces 110, 134 may be operatively configured to communicate with one or more components of the aircraft controller 102 and/or the one or more offboard controllers 124. For example, the one or more communication interfaces 110, 134 may also be coupled (e.g., physically, electrically, and/or communicatively) with the one or more processors 104, 126 to facilitate data transfer between components of the one or more components of the aircraft controller 102 and/or the one or more offboard controllers 124 and the one or more processors 104, 126. For instance, the one or more communication interfaces 110, 134 may be configured to retrieve data from the one or more processors 104, 126, or other devices, transmit data for storage in the memory 106, 128, retrieve data from storage in the memory 106, 128, or the like. By way of another example, the aircraft controller 102 and/or the one or more offboard controllers 124 may be configured to receive and/or acquire data or information from other systems or tools by a transmission medium that may include wireline and/or wireless portions. By way of another example, the aircraft controller 102 and/or the one or more offboard controllers 124 may be configured to transmit data or information (e.g., the output of one or more procedures of the inventive concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the aircraft controller 102 and/or the one or more offboard controllers 124 and the other subsystems (e.g., of the aircraft 100 and/or the system 138). In addition, the aircraft controller 102 and/or the one or more offboard controllers 124 may be configured to send data to external systems via a transmission medium (e.g., network connection).

The one or more display devices 112 may include any display device known in the art. For example, the display devices 112 may include, but are not limited to, one or more head-down displays (HDDs), one or more HUDs, one or more multi-function displays (MFDs), or the like. For instance, the display devices 112 may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, or the like. Those skilled in the art should recognize that a variety of display devices may be suitable for implementation in the present invention and the particular choice of display device may depend on a variety of factors, including, but not limited to, form factor, cost, and the like. In a general sense, any display device capable of integration with the user input device (e.g., touchscreen, bezel mounted interface, keyboard, mouse, trackpad, and the like) is suitable for implementation in the present invention.

The one or more user input devices 114 may include any user input device known in the art. For example, the user input device 114 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device, or the like. In the case of a touchscreen interface, those skilled in the art should recognize that a large number of touchscreen interfaces may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

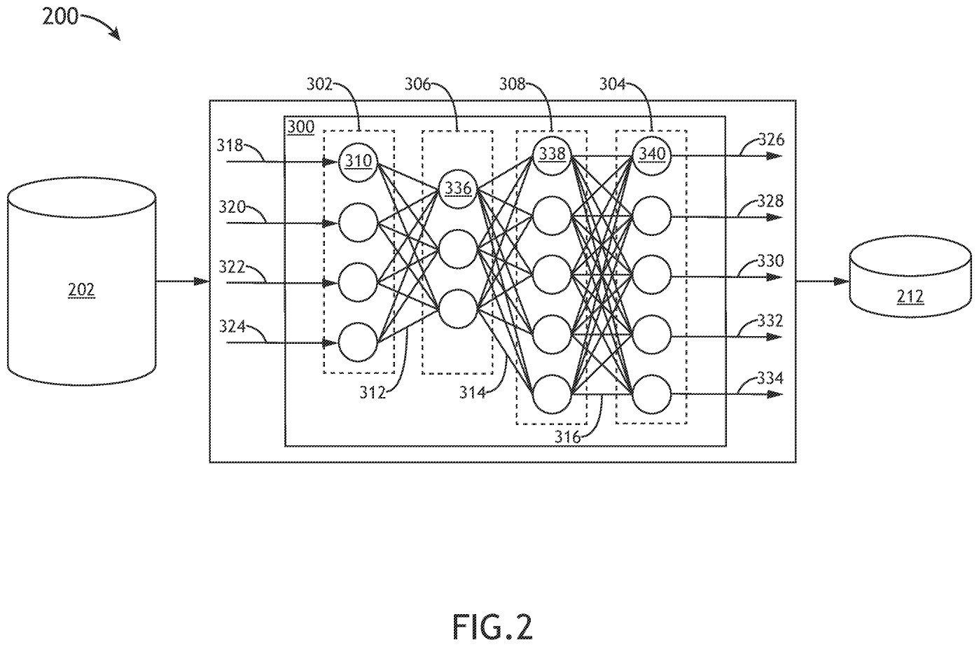

FIG. 2 illustrates a conceptual block diagram 200 of training a neural network 300 configured to output preset suggestions (e.g., suggested values for selectively configurable parameters controlling cabin features such as suggested temperature values), in accordance with one or more embodiments of the present disclosure.

The processors 104 may be configured to train a neural network 300.

The training may include iteratively improving a neural network 300 to generate/refine/train a (trained) neural network 212. For example, the training may be based on known inputs and known outputs, such as historical preference data and preset values (e.g., temperature values, lighting level values, etc.) of cabin features.

For instance, the system 138 (e.g., processors 126, 104) may be configured to train the neural network 300 based on data 202. For example, the data 202 may include the preset preferences 202 (e.g., received from user input), flight data 202, historic data (e.g., of user presets) and/or any other data disclosed herein.

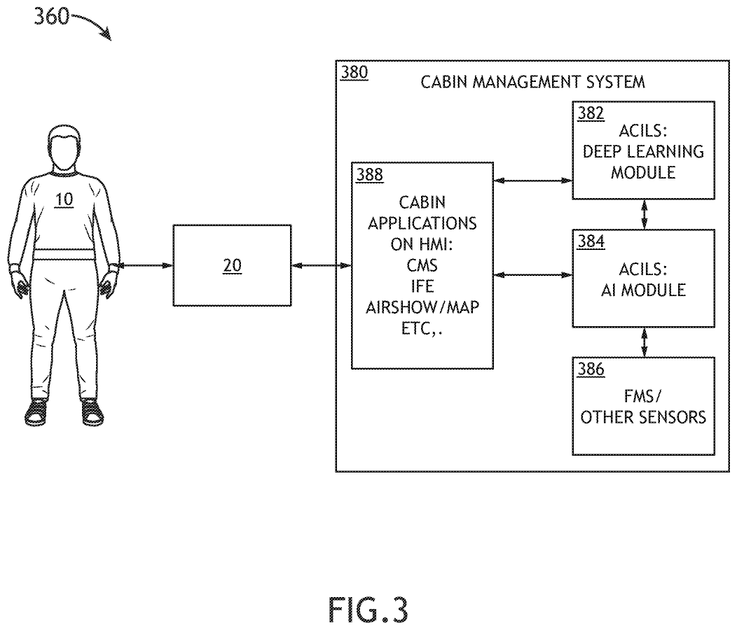

FIG. 3 illustrates a conceptual block diagram 360 of a cabin management system (CMS) 380, in accordance with one or more embodiments of the present disclosure.

The CMS 380 may include the system 138. The system 138 may include the CMS 380. For example, the CMS 380 may include one or more aircraft controllers 102 with program instructions configured to control the cabin features.

The CMS 380 may be configured to receive user input (e.g., touchscreen input) of a user 10 (e.g., physical person), such as via a user interface 116. For instance, the user interface 116 may include (or be) a touchscreen display 116.

The CMS 380 may be configured to receive user input 20 (e.g., conceptually) via any number of user input devices 114 including, for example, touch devices (e.g., touchscreen display), voice devices (e.g., microphone), switches (e.g., physical switches, knobs, buttons, and/or the like), and/or the like.

The CMS 380 may include program instructions such as applications 388 configured to receive (as input) the user input 20. For example, the applications 388 may be or include airshow applications, CMS modules (e.g., functions, sub-applications) configured to control cabin features, and/or the like.

The neural network 300 may include one or more neural networks such as a first neural network 382 and a second neural network 384. For example, these applications 388 may be configured to transmit the user input 20 (and any other data) to a deep learning module 382 and/or an artificial intelligence module 384.

The deep learning module 382 may be referred to as an Aircraft Cabin Insight Learning System (ACILS). The deep learning module 382 may be configured to continuously gather and record data related to passenger preferences, cabin system settings, staff interactions, sensor data, historical data, and/or outside influences (e.g., brightness of the ambient outdoors from camera sensor data) during flight, and further configured to perform real-time data integration of the data.

The artificial intelligence module 384 may be referred to as an Aircraft Cabin Artificial Intelligence System (ACAIS). The artificial intelligence module 384 may be in data communication with the ACILS 382, and configured to process, analyze, and/or learn from the gathered data to recommend and configure intelligent and dynamic cabin presets based on flight conditions (e.g., within 5 minutes of landing, takeoff, at a particular elevation where it is safe to walk in the cabin, and/or the like), passenger preset preferences, previous real-time interactions, present circumstances, and in-flight data.

The CMS 380 may include (as shown) and/or be communicatively coupled to other sensors/modules 386 and the like. For example, the flight management system 120 may be a sensor 386. For example, the occupancy sensors may be a sensor 386.

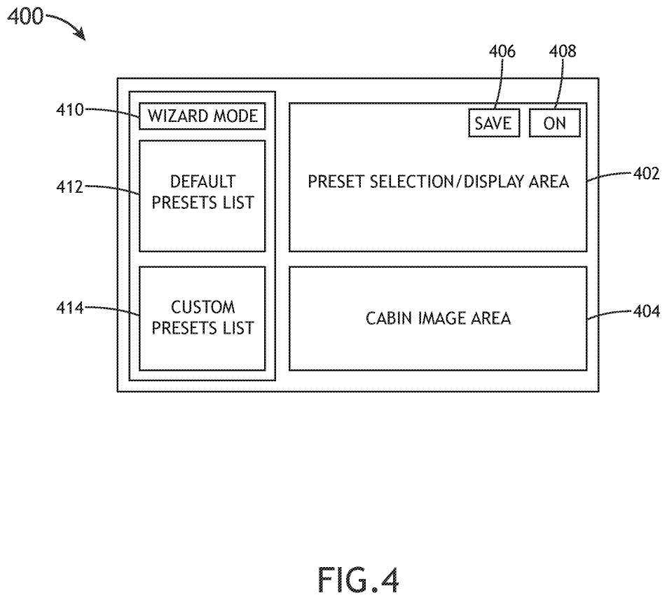

FIG. 4 illustrates a graphical user interface (GUI) 400 including global presets (e.g., default presets that are fixed and/or not associated with a unique user), in accordance with one or more embodiments of the present disclosure.

The touchscreen display 116 (which may be located throughout a cabin of a business jet or the like) includes a GUI (e.g., GUI 400). The GUI is configured to control cabin features (e.g., adjust temperature, seat positions, lighting, etc.) corresponding to an aircraft cabin of the aircraft 100.

Controlling which preset mode is being used and controlling values of those presets in that mode may be controlled by selecting the mode option and then viewing and controlling/inputting values in the preset display area 402. For example, the presets saved/generated in each mode may be shown in the preset display area 402 and may be swapped out depending on selection of panels on the left (or right) side. For instance, the modes may be changed by selecting one or more of a second suggestion mode activation area 410 (e.g., for using the neural network 300 ‘wizard’), a default preset list area 412, and a custom preset list area 414.

The GUI 400 may include a suggestion mode activation area 408. The suggestion mode activation area 408 may provide a benefit of being able to easily switch between using and not using the neural network 300 for generating preset suggestions.

The GUI 400 may include a save area 408 (e.g., save button), which may be adjacent to the suggestion mode activation area 408.

The GUI 400 may include a preset display area 402. The preset display area 402 may include the suggestion mode activation area 408. The preset display area 402 may include the save area 408. The preset display area 402 may enabled a selective control of parameters of one or more settings (e.g., presets) corresponding to cabin features. This may allow selecting presets and/or options to customize and save. For example, dials, up and down arrows, sliding scales, switches, number input boxes, and/or the like may be used to adjust cabin features, such as a sliding temperature scale a user 10 drags to their desired temperature.

The GUI 400 may include a default preset list area 412. Upon selection, the default preset list area 412 may enable default presets (e.g., user agnostic, fixed presets).

The GUI 400 may include a custom preset list area 414. Upon selection, the default preset list area 412 may enable custom presets (e.g., manually entered in the past and saved, rather than suggested by a neural network).

The GUI 400 may include a second suggestion mode activation area 410. For example, the second suggestion mode activation area 410 may be configured to display the suggestion mode activation area 408 and suggested presets in the preset display area 402.

The GUI 400 may include a cabin image area 404. The cabin image area 404 may include a visual representation of the cabin features and their (current) values and/or presets. For example, the cabin image area 404 may include visuals that reflect the cabin's ambience as affected by the preset choices, such as showing windows with shade graphics in a position that reflects the actual shade parameter preset values and actual real world positions of the window shades, such as may correspond to preset suggestion (values).

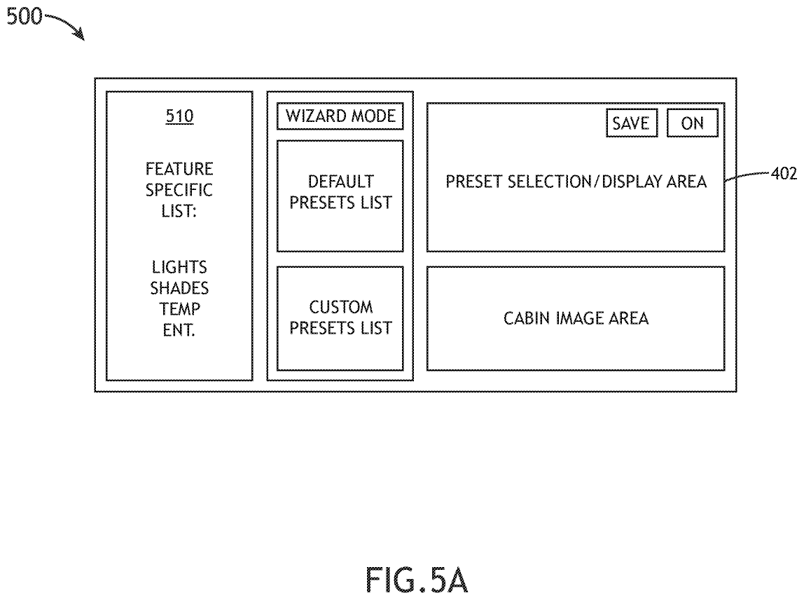

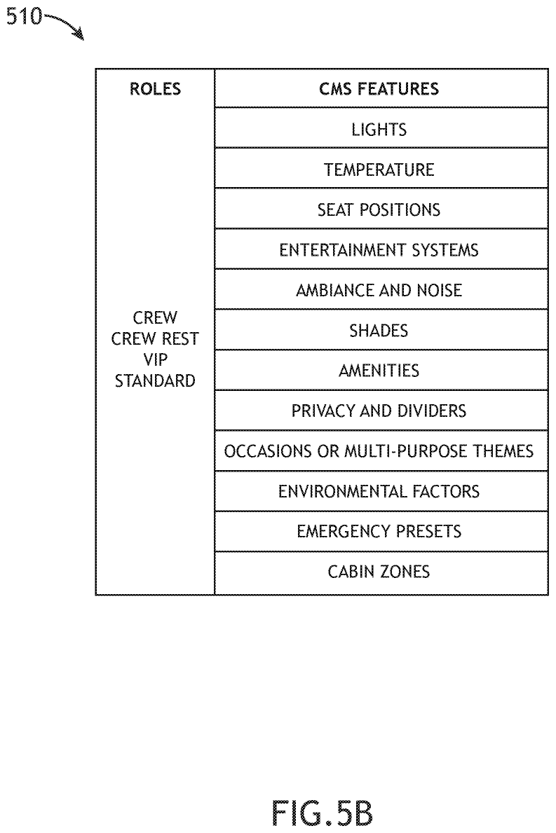

FIG. 5A illustrates a graphical user interface (GUI) in a feature suggestion mode, in accordance with one or more embodiments of the present disclosure.

The GUI 400 may include a feature list area 510 listing the cabin features (e.g., just the names of individual cabin features). Selecting a cabin feature may, for example, display the cabin feature and its corresponding preset value in the preset display area 402. This may allow for quickly selecting and adjusting cabin features.

FIG. 5B illustrates a feature specific list area 510 of FIG. 5A, in accordance with one or more embodiments of the present disclosure.

The feature specific list area 510 displays two or more cabin features in a column.

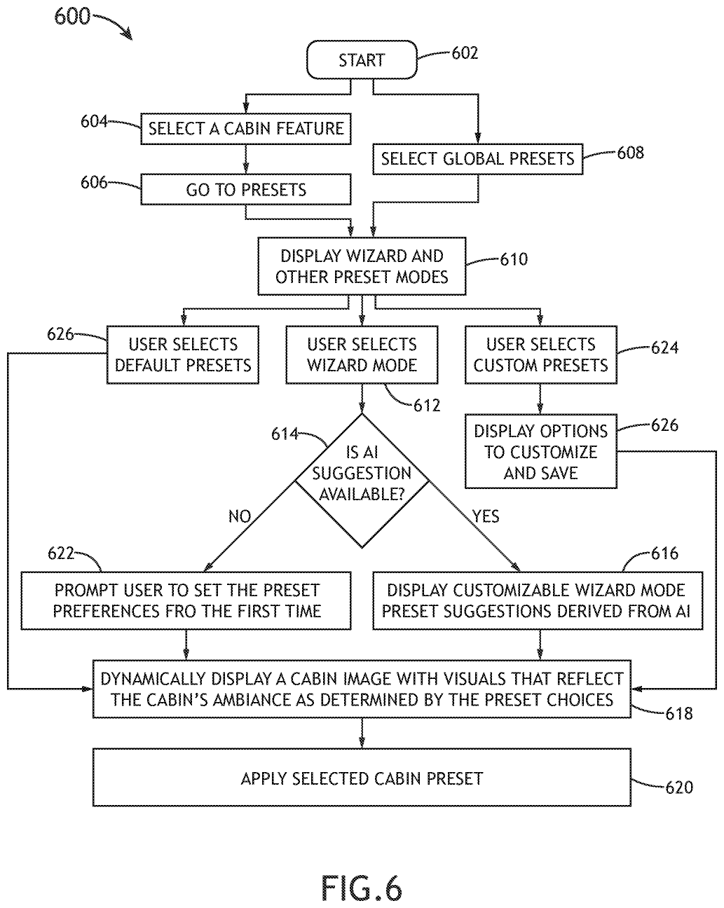

FIG. 6 illustrates a flow diagram illustrating steps performed in a method 600 for adjusting cabin features based on preset suggestions, in accordance with one or more embodiments of the present disclosure. For example, the method 600 may be implemented on processor 104.

At step 602, the method 600 may be started (e.g., booting up controller 102).

At step 604, an option (not shown) for expanding a cabin feature list is selected, such as for displaying and expanding the feature list 510.

At step 606, based on step 604, the feature list 510 is displayed.

At step 608, alternatively, global presets are displayed, such as shown in FIG. 4. For example, global presets may be displayed by default.

At step 610, in each scenario above, an option for enabling the suggestion of presets may be shown, such as suggestion mode activation area 410.

As noted, a user may select, in some examples, three options for displaying presets, such as shown in steps 626, 624, 612, and corresponding to areas such as areas 412, 414, 410, respectively.

At step 626, a user may select default preset list area 412.

At step 624, a user may select custom preset list area 414. For each of step 626 and 624, the cabin image area 404 may be displayed at step 620 based on the respective preset selections/values.

At step 612, a user may select the second suggestion mode activation area 410.

At step 614, an activation of the preset suggestion mode is further based on an affirmative determination that the preset suggestion mode is available. For example, the system may determine whether a user is a first-time user, lacking user preference data, and thereby make the mode unavailable until after user preference data is queried and received from the user. The determination of availability may be based on the user identification (e.g., the user signing in or identifying the user through known facial recognition and camera sensors in the cabin).

At step 622, if a negative/unavailable determination is made, the user may enter their preset preferences for the first time.

At step 616, if a positive/available determination is made, preset suggestions (e.g., generated by neural network 300) may be displayed (e.g., displayed in preset display area 402), which may be customizable (e.g., modifying by adjusting parameters in the preset display area 402).

At step 620. the cabin image area 404 may be displayed at step 620 based on respective preset parameter values.

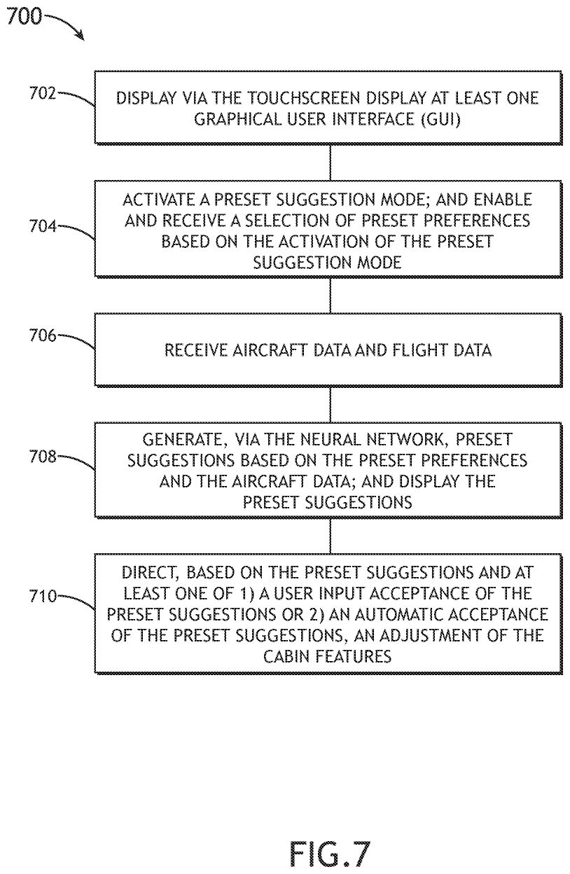

FIG. 7 illustrates a flow diagram illustrating steps performed in a method 700 for adjusting cabin features based on preset suggestions, in accordance with one or more embodiments of the present disclosure.

At step 702, the graphical user interface (GUI) 400 may be configured to control the cabin features corresponding to an aircraft cabin 100. The GUI 400 may include a suggestion mode activation area 408.

At step 704, a preset suggestion mode may be activated based on a user input (e.g., push on the touchscreen) of the suggestion mode activation area 408 via the touchscreen display 116.

At step 704, a selection of preset preferences may be enabled based on the activation of the preset suggestion mode. This allows the user to customize their cabin experience according to their preferences.

At step 704, the preset preferences may be received based on preset preference user input via the touchscreen display 116. This user input may be used to adjust the cabin features according to the user's preferences, may be used for training the neural network 300, and/or may be used as input to the neural network 300 during run-time/inference.

At step 706, aircraft data comprising at least flight data (e.g., GPS location, altitude, speed, time of day, duration of flight, and/or the like) may be received (e.g., uploaded from the cloud wirelessly). In examples, the aircraft data may include aircraft usage data (e.g., how or why the aircraft is used, such as for business purposes versus personal/leisure purposes; and/or the like).

At step 706, a neural network 300 may be received. The neural network 300 may be used to generate preset suggestions based on the preset preferences and the aircraft data (e.g., as inputs to the neural network 300).

At step 708, preset suggestions may be generated (e.g., as outputs) via the neural network 300 based on the preset preferences and the aircraft data. These preset suggestions may be used to further customize the cabin experience for the user.

At step 708, the preset suggestions may be displayed on the GUI 400. This may allow the user to review the preset suggestions and decide whether to accept, reject, and/or modify them.

At step 710, an adjustment of the cabin features may be directed (e.g., directing signals to be sent out using controller 102, such as signals configured to adjust temperature control systems, window shade actuators, and the like) based on the preset suggestions and at least one of 1) a user input acceptance/confirmation of the preset suggestions or 2) an automatic acceptance of the preset suggestions (e.g., no user acceptance needed). The cabin features may include at least one of: a window level of one or more window shades; temperature control systems; or a cabin lighting level of one or more lights or any other feature of FIG. 5B. This step allows the cabin features to be adjusted according to the preset suggestions, thereby customizing the cabin experience for the user.

Individual Passenger preset suggestions can be suggested in features like Personalized Lighting, Temperature Controls, Seat Adjustments, Entertainment Selections.

Referring back to FIG. 2, a block diagram of a neural network 300 according to embodiments of the inventive concepts disclosed herein is shown. The neural network 300 comprises an input layer 302 that receives external inputs (including flight data, user preferences, and/or the like), and output layer 304, and a plurality of internal layers 306, 308. Each layer comprises a plurality of neurons or nodes 310, 336, 338, 340. In the input layer 302, each node 310 receives one or more inputs 318, 320, 322, 324 corresponding to a digital signal and produces an output 312 based on an activation function unique to each node 310 in the input layer 302. An activation function may be a hyperbolic tangent function, a linear output function, and/or a logistic function, or some combination thereof, and different nodes 310, 336, 338, 340 may utilize different types of activation functions. In at least one embodiment, such activation function comprises the sum of each input multiplied by a synaptic weight. The output 312 may comprise a real value with a defined range or a Boolean value if the activation function surpasses a defined threshold. Such ranges and thresholds may be defined during a training process. Furthermore, the synaptic weights are determined during the training process.

Outputs 312 from each of the nodes 310 in the input layer 302 are passed to each node 336 in a first intermediate layer 306. The process continues through any number of intermediate layers 306, 308 with each intermediate layer node 336, 338 having a unique set of synaptic weights corresponding to each input 312, 314 from the previous intermediate layer 306, 308. It is envisioned that certain intermediate layer nodes 336, 338 may produce a real value with a range while other intermediate layer nodes 336, 338 may produce a Boolean value. Furthermore, it is envisioned that certain intermediate layer nodes 336, 338 may utilize a weighted input summation methodology while others utilize a weighted input product methodology. It is further envisioned that synaptic weight may correspond to bit shifting of the corresponding inputs 312, 314, 316.

An output layer 304 including one or more output nodes 340 receives the outputs 316 from each of the nodes 338 in the previous intermediate layer 308. Each output node 340 produces a final output 326, 328, 330, 332, 334 via processing the previous layer inputs 316, the final output 326, 328, 330, 332, 334 corresponding to cabin presets. Such outputs may comprise separate components of an interleaved input signal, bits for delivery to a register, or other digital output based on an input signal and DSP algorithm.

In at least one embodiment, each node 310, 336, 338, 340 in any layer 302, 306, 308, 304 may include a node weight to boost the output value of that node 310, 336, 338, 340 independently of the weighting applied to the output of that node 310, 336, 338, 340 in subsequent layers 304, 306, 308. It may be appreciated that certain synaptic weights may be zero to effectively isolate a node 310, 336, 338, 340 from an input 312, 314, 316, from one or more nodes 310, 336, 338 in a previous layer, or an initial input 318, 320, 322, 324.

In at least one embodiment, the number of processing layers 302, 304, 306, 308 may be constrained at a design phase based on a desired data throughput rate. Furthermore, multiple processors and multiple processing threads may facilitate simultaneous calculations of nodes 310, 336, 338, 340 within each processing layers 302, 304, 306, 308.

Layers 302, 304, 306, 308 may be organized in a feed forward architecture where nodes 310, 336, 338, 340 only receive inputs from the previous layer 302, 304, 306 and deliver outputs only to the immediately subsequent layer 304, 306, 308, or a recurrent architecture, or some combination thereof.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system comprising:
a touchscreen display; and
one or more controllers communicatively coupled to the touchscreen display including one or more processors configured to execute a set of program instructions stored in a memory, the set of program instructions configured to cause the one or more processors to:
display, via the touchscreen display, at least one graphical user interface (GUI) configured to control cabin features corresponding to an aircraft cabin, wherein the GUI includes:
a suggestion mode activation area;
activate a preset suggestion mode based on a user input of the suggestion mode activation area via the touchscreen display by a user;
enable a selection of preset preferences based on the activation of the preset suggestion mode;
receive the preset preferences based on preset preference user input via the touchscreen display;
receive aircraft data comprising at least flight data;
receive a neural network;
generate, via the neural network, preset suggestions based on the preset preferences and the aircraft data;
display the preset suggestions on the GUI; and
direct, based on the preset suggestions and at least one of 1) a user input acceptance of the preset suggestions or 2) an automatic acceptance of the preset suggestions, an adjustment of the cabin features, wherein the cabin features include at least one of:
a window level of one or more window shades;
temperature control systems; or
a cabin lighting level of one or more lights.

2. The system of claim 1, wherein the preset suggestions are further based on a user identification corresponding and unique to the user.

3. The system of claim 1, wherein the one or more processors are further configured to train the neural network based on the preset preferences.

4. The system of claim 1, wherein the GUI comprises a preset display area.

5. The system of claim 4, wherein the preset display area comprises the suggestion mode activation area.

6. The system of claim 1, wherein the aircraft data further comprises occupancy data based on occupancy sensors configured to sense the user in the aircraft cabin and to associate the user with a user identification.

7. The system of claim 1, wherein the GUI comprises a feature list area configured to list the cabin features.

8. The system of claim 1, wherein the GUI comprises a default preset list area and a custom preset list area.

9. The system of claim 1, wherein the GUI comprises a cabin image area comprising a visual representation of the cabin features.

10. The system of claim 1, wherein the activation of the preset suggestion mode is further based on an affirmative determination that the preset suggestion mode is available.

11. The system of claim 1, wherein the aircraft data further comprises aircraft usage data.

12. A method comprising:
displaying, via a touchscreen display, at least one graphical user interface (GUI) configured to control cabin features corresponding to an aircraft cabin, wherein the GUI includes a suggestion mode activation area;
activating a preset suggestion mode based on a user input of the suggestion mode activation area via the touchscreen display;
enabling a selection of preset preferences based on the activation of the preset suggestion mode by a user;
receiving the preset preferences based on preset preference user input via the touchscreen display;
receiving aircraft data comprising at least flight data;
receiving a neural network;
generating, via the neural network, preset suggestions based on the preset preferences and the aircraft data;
displaying the preset suggestions on the GUI; and
directing, based on the preset suggestions and at least one of 1) a user input acceptance of the preset suggestions or 2) an automatic acceptance of the preset suggestions, an adjustment of the cabin features, wherein the cabin features include at least one of:
a window level of one or more window shades;
temperature control systems; or
a cabin lighting level of one or more lights.

13. The method of claim 12, wherein the preset suggestions are further based on a user identification corresponding and unique to the user.

14. The method of claim 12 further comprising training the neural network based on the preset preferences.

15. The method of claim 12, wherein the GUI comprises a preset display area.

16. The method of claim 15, wherein the preset display area comprises the suggestion mode activation area.

17. The method of claim 12, wherein the aircraft data further comprises occupancy data based on occupancy sensors configured to sense the user in the aircraft cabin and to associate the user with a user identification.

18. The method of claim 12, wherein the GUI comprises a feature list area configured to list the cabin features.

19. The method of claim 12, wherein the GUI comprises a default preset list area and a custom preset list area.

20. The method of claim 12, wherein the GUI comprises a cabin image area comprising a visual representation of the cabin features.
